(19) United States
(12) Patent Application Publication
(10) Pub. No.: US 2013/0129333 A1
(43) Pub. Date: May 23, 2013

(54) APPARATUS FOR MEASURING DIETARY OUTCOME AND SYSTEM USING THE SAME

(71) Applicant: Ohwon KWON, Seoul (KR)

(72) Inventor: Ohwon KWON, Seoul (KR)

(21) Appl. No.: 13/657,173

(22) Filed: Oct. 22, 2012

(30) Foreign Application Priority Data
Nov. 21, 2011 (KR) 2011-0121594

(51) Int. Cl. G03B 15/00

(52) U.S. Cl. 396/3

(57) ABSTRACT

An apparatus for measuring dietary outcome and a system using the same are provided. The system for measuring dietary outcome includes an apparatus for measuring dietary outcome, a location identification label formed on a central bottom surface of the apparatus for measuring dietary outcome; and a camera disposed in front of the apparatus for measuring dietary outcome. Here, the apparatus for measuring dietary outcome includes a screen member, a rod member configured to wind the screen member, a housing coupled to both sides of the rod member so as to perform rotation of the rod member, and a drive unit coupled to the rod member and configured to unwind or wind the rod member by allowing a user to rotate the rod member. Here, a plurality of measuring lines are marked on the screen member in a longitudinal direction.

### CROSS-REFERENCE TO RELATED APPLICATION

This application claims priority to and the benefit of Korean Patent Application No. 2011-0121594, filed Nov. 21, 2011, the disclosure of which is incorporated herein by reference in its entirety.

### BACKGROUND

1. Field of the Invention

The present invention relates to an apparatus for measuring dietary outcome and a system using the same, and more particularly, to a medical apparatus and system which enable a patient to readily check a dietary course by measuring a change in body shape with time.

2. Discussion of Related Art

In the prior art, the dietary outcome refers to a change in body weight, and thus the success in diet is determined by measuring the change in body weight. However, the dietary outcome is visually presented so as to encourage patients to do diet. Especially, the diet clinics or diet centers should stimulate their clients to continuously do diet, giving the feeling of accomplishment to them. For this purpose, apparatuses or systems which enable the clients to directly check their dietary outcome during the dietary course need to be developed.

### SUMMARY OF THE INVENTION

The present invention is designed to solve the problems of the prior art, and therefore it is an object of the present invention to provide an apparatus for measuring dietary outcome capable of being easily stored and allowing an obese patient to check his/her own body shape, and a system using the same.

It is another object of the present invention to provide a system for measuring dietary outcome capable of allowing an obese patient to check the date which a picture is taken of his/her body shape.

It is still another object of the present invention to provide an apparatus for measuring dietary outcome, which includes measuring lines marked at a constant distance in a longitudinal direction so as to easily check a change in body shape of an obese patient, the respective measuring lines being subjected to changes in color, and a system using the same.

It is yet another object of the present invention to provide a system for measuring dietary outcome including a location identification label marked on the ground so as to allow a patient to stand at the same place.

One aspect of the present invention provides an apparatus for measuring dietary outcome, which includes a screen member, a rod member configured to wind the screen member, a housing coupled to both sides of the rod member so as to perform rotation of the rod member, and a drive unit coupled to the rod member and configured to unwind or wind the screen member by allowing a user to rotate the rod member. Here, a plurality of measuring lines are marked on the screen member in a longitudinal direction.

In this case, the measuring lines may include a center line, and a plurality of peripheral lines formed outwardly at a constant distance from the center line.

Also, the plurality of peripheral lines may have different colors, depending on the distances from the center line.

In addition, the screen member may have a date display portion formed thereon.

Another aspect of the present invention provides a system for measuring dietary outcome, which includes an apparatus for measuring dietary outcome, a location identification label formed on a central bottom surface of the apparatus for measuring dietary outcome, and a camera disposed in front of the apparatus for measuring dietary outcome. Here, the apparatus for measuring dietary outcome includes a screen member, a rod member configured to wind the screen member, a housing coupled to both sides of the rod member so as to perform rotation of the rod member, and a drive unit coupled to the rod member and configured to unwind or wind the screen member by allowing a user to rotate the rod member. Here, a plurality of measuring lines are marked on the screen member in a longitudinal direction.

In this case, the measuring lines include a center line, and a plurality of peripheral lines formed outwardly at a constant distance from the center line.

### BRIEF DESCRIPTION OF THE DRAWINGS

The above and other objects, features and advantages of the present invention will become more apparent to those of ordinary skill in the art by describing in detail exemplary embodiments thereof with reference to the attached drawing, in which:

FIG. 1 is a diagram showing an apparatus for measuring dietary outcome and a system using the same according to one exemplary embodiment of the present invention.

### DETAILED DESCRIPTION OF EXEMPLARY EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

It will be understood that, although the terms first, second, A, B, etc. may be used herein in reference to elements of the invention, such elements should not be construed as limited by these terms. For example, a first element could be termed a second element, and to second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

With reference to the appended drawings, exemplary embodiments of the present invention will he described in detail below. To aid in understanding the present invention, like numbers refer to like elements throughout the description of the figures, and the description of the same elements will be not reiterated.

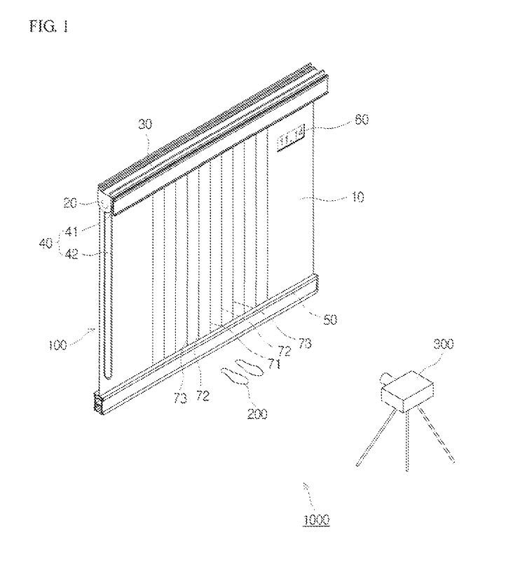

FIG. 1 is a diagram showing an apparatus for measuring dietary outcome and a system using the same according to one exemplary embodiment of the present invention.

The apparatus 100 for measuring dietary outcome according to this exemplary embodiment is characterized in that it includes a screen member 10, a rod member 20 configured to wind the screen member 10, a housing 30 coupled to both sides of the rod member 20 so as to perform rotation of the rod member 20, and a drive unit 40 coupled to the rod member 20 and configured to unwind or wind the screen member 10 by allowing a user to rotate the rod member 20. Here, a plurality of measuring lines 71, 72 and 73 are marked on the screen member 10 in a longitudinal direction.

The apparatus 100 for measuring dietary outcome according to this exemplary embodiment is an apparatus that allows a patient who wants to do diet to visually check to what extent the external shapes of hips, a waist or arms overlap the measuring lines 71, 72 and 73 when the patient stands in front of the apparatus 100 for measuring dietary outcome.

The apparatus 100 for measuring dietary outcome according to this exemplary embodiment may be used by unwinding the screen member 10 downwardly, as necessary, in a state in which the housing 30 is held on the wall or ceiling. Therefore, the apparatus 100 for measuring dietary outcome has advantages in that it is spacious in the use of the apparatus 100 for measuring dietary and contamination of dust or pollutants is prevented since the screen member 10 is wound into the rod member 20 when the apparatus 100 for measuring dietary is not used.

The entire appearance of the apparatus 100 for measuring dietary outcome according to this exemplary embodiment resembles a roll screen used to shield light through a window. Thus, the shape and functions of the apparatus 100 for measuring dietary outcome are substantially identical to a configuration of the roll screen. Therefore, detailed descriptions of the shape and functions of the apparatus 100 for measuring dietary outcome are omitted for clarity.

The screen member 10 may be formed of a fabric. Also, the screen member 10 may be formed of paper, a nonwoven fabric, or a synthetic resin. Any materials may be used as the screen member 10 without limitation as long as they have sufficient durability to prevent the screen member 10 from easily getting rumpled.

A plurality of measuring lines 71, 72 and 73 are marked on the screen member 10 in a longitudinal direction. The measuring lines include a center line 71 disposed in the center and a plurality of peripheral lines 72 and 73 formed outwardly at a constant distance from the center. The center line 71 may be one or two or more lines. The peripheral lines 72 and 73 may have difference colors, depending on the distances from the center line 71. This is to readily distinguish the peripheral lines 72 from the center line 71 when viewed from the outside with the naked eye. For example, 72^{nd} peripheral lines may be marked red and 73^{rd} peripheral lines may be marked blue.

A date display portion 60 is formed at the screen member 10. A space for making a note of years. Months and days may be provided in the date display portion 60. In this case, the date may be marked using a pen. Also, the date may be marked a sticker or a numeric keypad. The apparatus 100 for measuring dietary outcome according to this exemplary embodiment is an apparatus for checking a dietary effect with time. Therefore, the body shape should be observed and recorded with the passage of time. When a patient stands in front of the screen member 10 according to this exemplary embodiment and a picture is taken of the patient, the patient may automatically check what date the picture is taken due to the date of the date display portion 60. When these pictures are continuously taken for a certain period of time, the pictures may be used to easily check how an external body shape of the patient is changed during the dietary course.

The rod member 20 has a long bar shape to wind the screen member. The rod member 20 may have a hollow inner part like a pipe. The rod member 20 may be formed of a material such as a plastic, a metal or wood.

A housing 30 is coupled to both ends of the rod member 20. The rod member 20 may be rotatably coupled to the housing 30. The housing 30 may further include a bracket formed so that the housing 30 can be fixed on the wall or ceiling. When the housing 30 is fixed on the wall, the rod member 20 is rotated to unwind or wind the screen member 10.

The drive unit 40 is coupled to the rod member 20 to enable a user to rotate the rod member 20. The drive unit 40 according to this exemplary embodiment includes a circularly curved member 41 coupled to the rod member 20, and a line member 42 coupled to the circularly curved member 41. When the line member 42 is pulled in one direction, the circularly curved member 41 rotates, and the rod member 20 coupled to the circularly curved member 41 also rotates, thereby unwinding or winding the screen member 10.

Such a configuration of the drive unit 40 may apply to all systems used when the screen member 10 is unwound or wound from the roll screen. The drive unit 40 according to this exemplary embodiment may be manually driven, or automatically driven by rotating the rod member 20 by means of a force of a motor. Therefore, according to the present invention, the drive unit 40 defined in the claims may be selectively driven using all methods such as manual driving and automatic driving, as known in the art.

The system 1000 for measuring dietary outcome includes an apparatus 100 for measuring dietary outcome, a location identification label 200 formed on a central bottom surface of the apparatus 100 for measuring dietary outcome, and a camera 300 in front of the apparatus 100 for measuring dietary outcome. Here, the apparatus 100 for measuring dietary outcome includes a screen member 10, a rod member 20 configured to wind the screen member 10, a housing 30 coupled to both ends of the rod member 20 so as to perform rotation of the rod member 20, and a drive unit 40 coupled to the rod member and configured to unwind or wind the screen member 10 by allowing a user to rotate rod member 20. Here, a plurality of measuring lines 71, 72 and 73 are marked on the screen member 10 in a longitudinal direction.

The system 1000 for measuring dietary outcome according to this exemplary embodiment is a system for continuously yielding dietary outcome in the form of pictures with time. The apparatus 100 for measuring dietary outcome has been described in further detail, and thus detailed description of the system 1000 for measuring dietary outcome is omitted for clarity.

A location identification label 200 is formed on the ground in the center in front of the apparatus 100 for measuring dietary outcome according to this exemplary embodiment. The location identification label 200 may be in various shapes. According to this exemplary embodiment, the location identification label 200 may be in the form of the sole of the foot. A patient who wants to measure the dietary outcome stands on the location identification label 200 in the form of the sole of the foot. As a result, since the patient always stands at the same location, the patient may be positioned at the same location of the apparatus 100 for measuring dietary outcome even when several pictures are taken of the patient at different times. Accordingly, it is possible to check a change in body shape during the dietary course.

Any types of the location identification label 200 may be used without limitation as long as they provide a position at which the patient's feet are arranged. The location identification label 200 may be marked by attaching an adhesive tape onto the group, or marked using or paint.

Meanwhile, the camera 300 is positioned in front of the apparatus 100 for measuring dietary outcome. The camera 300 may be positioned in a fixed location. The camera 300 may be used to continuously store patient's dietary recordings. A digital camera may be used as the camera 300, but a polaroid camera system may also be used as the camera 300.

According to one exemplary embodiment of the present invention, the apparatus for measuring dietary outcome capable of being easily stored and allowing an obese patient to check his/her own body shape, and a system using the same can be provided.

According to another exemplary embodiment of the present invention, the system for measuring dietary outcome capable of allowing an obese patient to check the date which a picture is taken of his/her body shape can be provided.

According to still another exemplary embodiment of the present invention, the apparatus for measuring dietary outcome, which includes measuring lines marked at a constant distance in a longitudinal direction so as to easily check a change in body shape of an obese patient, the respective measuring lines being subjected to changes in color, and a system using the same can be provided.

According to yet another exemplary embodiment of the present invention, the system for measuring dietary outcome including a location identification label marked on the ground so as to allow a patient to stand at the same place can be provided.

While the invention has been shown and described with reference to certain exemplary embodiments thereof, it will be understood by those skilled in the art that various changes in form and details may be made therein without departing from the scope of the invention as defined by the appended claims.

What is claimed is:

1. An apparatus for measuring dietary outcome, comprising:
a screen member;
a rod member configured to wind the screen member;
a housing coupled to both ends of the rod member so as to perform rotation of the rod member; and
a drive unit coupled to the rod member and configured to unwind or wind the screen member by allowing a user to rotate the rod member,
wherein a plurality of measuring lines are marked on the screen member in a longitudinal direction.

2. The apparatus according to claim 1, wherein the measuring lines comprise:
a center line; and
a plurality of peripheral lines formed outwardly at a constant distance from the center line.

3. The apparatus according to claim 2, wherein the plurality of peripheral lines have different colors, depending on the distances from the center line.

4. The apparatus according to claim 3, wherein the screen member has a date display portion formed thereon.

5. A system for measuring dietary outcome, comprising:
an apparatus for measuring dietary outcome;
a location identification label formed on a central bottom surface of the apparatus for measuring dietary outcome; and
a camera positioned in front of the apparatus for measuring dietary outcome,
wherein the apparatus for measuring dietary outcome comprises:
a screen member;
a rod member configured to wind the screen member;
a housing coupled to both ends of the rod member so as to perform rotation of the rod member; and
a drive unit coupled to the rod member and configured to unwind or wind the screen member by allowing a user to rotate the rod member, wherein a plurality of measuring lines are marked on the screen member in a longitudinal direction.

6. The system according to claim 5, wherein the measuring lines comprise:
a center line; and
a plurality of peripheral lines formed outwardly at a constant distance from the center line.
